(19) United States
(12) Patent Application Publication
(10) Pub. No.: US 2008/0260186 A1
(43) Pub. Date: Oct. 23, 2008

(54) Speaker

(76) Inventor: Takeshi Nakamura, Kyoto-fu (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(21) Appl. No.: 10/595,206

(22) PCT Filed: Jan. 24, 2005
(86) PCT No.: PCT/JP2005/000864

§ 371 Date: Jul. 8, 2008

(30) Foreign Application Priority Data
Sep. 9, 2004 (JP) 2004-262047
Jan. 21, 2005 (JP) 2005-013554

(51) Int. Cl. H04R 1/02

(52) U.S. Cl. 381/152

(57) ABSTRACT

A speaker included in a speaker unit has a conical diaphragm. An end of a substantially circular cylindrical wall member is secured to the large-diameter end of the diaphragm. The inner surface of the wall member is arranged substantially parallel to a direction in which the diaphragm vibrates. Audio signals input to a voice coil cause the diaphragm and the wall member to vibrate in a direction that is substantially perpendicular to a surface of a cabinet. This causes air in front of the diaphragm to be compressed and then released. A shock that occurs when the compressed air is released propagates and is perceived as sound. The wall member prevents leakage of the compressed air from the front to the side of the diaphragm.

### BACKGROUND OF THE INVENTION

1. Field of the Invention

The present invention relates to speakers, and more particularly, to a speaker that emits sound waves by vibrating a diaphragm. Examples of such a speaker include a dynamic speaker and an electromagnetic speaker, each of which includes a voice coil.

2. Description of the Related Art

FIG. 10 is a perspective view showing an example of a conventional speaker unit. A speaker unit 1 includes a cabinet 2. A woofer (low frequency speaker) 3, a tweeter (high frequency speaker) 4 and a midrange speaker 5 are attached to a front panel of the cabinet 2. Diaphragms of the respective speakers 3, 4, and 5 vibrate to produce sound waves of corresponding frequencies.

For example, as shown in FIG. 11, the woofer 3 includes a conical diaphragm 6. A voice coil (not shown) causes the diaphragm 6 to vibrate back and forth. The inner bottom of the diaphragm 6 is connected via a damper 7 to a frame 8, while the large-diameter end of the diaphragm 6 is connected via a cone edge 9 to the frame 8. A duct 10 extends inwardly from the front panel of the cabinet 2. In the cabinet 2, the woofer 3 is attached to the duct 10 (see Japanese Unexamined Patent Application Publication No. 2002-232984 (Patent Document 1)).

In this speaker unit 1, the vibrations of the diaphragm 6 of the woofer 3 vibrate air in the duct 10, cause the duct 10 to resonate, and allow low frequency sounds enhanced by the resonation of the duct 10 to be reproduced through an opening of the duct 10.

However, such a conventional speaker has problems in that the diameter thereof must be large enough to reproduce low frequency sounds, and in that the resonance of the duct causes sound distortion.

### SUMMARY OF THE INVENTION

To overcome the problems described above, preferred embodiments of the present invention provide a small-diameter speaker capable of reproducing low frequency sounds that are free of distortion.

A speaker according to a preferred embodiment of the present invention includes a diaphragm arranged to vibrate in a direction extending along a surface, thereby emitting sound waves in the vibration direction of the diaphragm, and at least one wall member arranged on a sound-wave emission side of the diaphragm, wherein the wall member and the diaphragm are secured to each other, and the wall member vibrates along with the vibration of the diaphragm.

In such a speaker, the inner surface of the wall member is preferably arranged substantially parallel to the vibration direction of the diaphragm.

The wall member may preferably have the shape of a frame surrounding the sound-wave emission side of the diaphragm.

Moreover, the wall member may have a cross-sectional shape that is substantially the same as the rim shape of the sound-wave emission surface of the diaphragm.

In addition, the plurality of wall members may be arranged concentrically with respect to the center of the diaphragm.

The height of the wall member is preferably substantially the same as the maximum amplitude of the diaphragm.

A speaker according to another preferred embodiment of the present invention includes a diaphragm arranged to vibrate in a direction extending along a surface, thereby emitting sound waves in the vibration direction of the diaphragm, and a plurality of tubular elements touching and arranged side by side on a sound-wave emission side of the diaphragm, each of the tubular elements having an inner surface that is substantially parallel to the vibration direction of the diaphragm, wherein the tubular elements and the diaphragm are secured to each other, and the tubular elements vibrate along with the vibration of the diaphragm.

In such a speaker, the height of the tubular elements is preferably substantially the same as the maximum amplitude of the diaphragm.

The inventor of the present invention has discovered, as a principle of sound production (generation), that the vibrations of a diaphragm do not directly produce sound waves, but instead, initially cause air over a sound-wave emission surface of the diaphragm to be momentarily compressed and then immediately released at once, in other words, expanded, and the resulting shock propagates and is perceived as sound. Therefore, the speaker according to preferred embodiments of the present invention includes a wall member secured to a sound-wave emission side of a diaphragm which vibrates along with the diaphragm.

Thus, the speaker prevents leakage of air compressed by the vibrations of the diaphragm from the sound-wave emission surface (front surface) to the side of the diaphragm. This allows air with a compression rate according to the amount of vibrations (amplitude) of the diaphragm to be efficiently released to the sound-wave emission surface side (forward), thereby enabling low frequency sounds to be efficiently emitted even when the diameter of the diaphragm is small.

In addition to low frequency sounds, midrange and high frequency sounds are also efficiently emitted. Since the wall member is not designed for resonance, the wall member does not have to be as high as the length of a resonance duct. The wall member is high enough if it is substantially as high as the maximum amplitude of the diaphragm.

Therefore, the wall member causes no sound distortion due to resonance, and enables reproduction of high quality sound that accurately corresponds to the original source.

As described above, the wall member that vibrates along with the diaphragm is arranged on the sound-wave emission side of the diaphragm to prevent air compressed by the diaphragm from leaking from the sound-wave emission surface to the side of the diaphragm.

Preferably, the wall member has a frame shape surrounding the sound-wave emission surface of the diaphragm so as to prevent air captured on the sound-wave emission surface of the diaphragm from leaking.

In particular, if the wall member has a cross-sectional shape that is substantially the same as the rim shape of the sound-wave emission surface of the diaphragm, air over the entire surface of the diaphragm is captured.

In addition to the wall member on the rim of the diaphragm, a plurality of wall members may be provided to divide the inner portion of the rim into a plurality of sections. For example, a plurality of wall members, each having a cross section that is similar in shape to the rim of the diaphragm, is arranged concentrically with respect to the center of the diaphragm.

As described above, dividing the sound-wave emission side of the diaphragm into a plurality of sections reduces the area of a section surrounded by each wall member. Since this prevents air leakage and enables air to be confined inside the wall members, more accurate sound reproduction is achieved.

Moreover, since the wall members act as ribs to improve the stiffness of the diaphragm, deformation, such as surface waviness, is prevented. Thus, the reproduction of sounds that accurately correspond to the original source is achieved.

The height of the wall member is preferably substantially the same as the maximum amplitude of the diaphragm so as to prevent air compressed by the vibration of the diaphragm from escaping from the sound-wave emission surface.

To divide the sound-wave emission side of the diaphragm into a plurality of sections, a honeycomb wall member including a plurality of tubular elements touching side by side may be arranged on the sound-wave emission surface of the diaphragm.

The height of the tubular elements in such a speaker is also preferably substantially the same as the maximum amplitude of the diaphragm so as to prevent air compressed by the vibration of the diaphragm from escaping from the sound-wave emission surface.

Preferred embodiments of the present invention provide a speaker which reproduces sounds of all frequencies ranging from low to high frequencies that accurately correspond to input signals, and in particular, a speaker which is capable of reproducing low frequency sounds even with a small diameter.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view showing an example of a speaker unit that includes a speaker according to a preferred embodiment of the present invention.

FIG. 2 illustrates the structure of the speaker unit shown in FIG. 1.

FIG. 3 illustrates a diaphragm and a wall member of the speaker included in the speaker unit shown in FIG. 2.

FIG. 4 illustrates the relationship between the vibration of the diaphragm shown in FIG. 3 and the compression of air.

FIG. 5 illustrates the relationship between the vibration of a conventional diaphragm and the compression of air, for the purpose of comparison with the present invention.

FIG. 6 illustrates another example of a diaphragm and wall members of a speaker according to a preferred embodiment of the present invention.

FIG. 7 illustrates the structure of the speaker including the diaphragm and wall members shown in FIG. 6.

FIG. 8 is a plan view showing still another example of a wall member included in the speaker according to a preferred embodiment of the present invention.

FIG. 9 illustrates the diaphragm with the wall member shown in FIG. 8.

FIG. 10 is a perspective view showing an example of a speaker unit including a conventional speaker.

FIG. 11 illustrates an example of a conventional speaker included in FIG. 10.

### DETAILED DESCRIPTION OF PREFERRED EMBODIMENTS

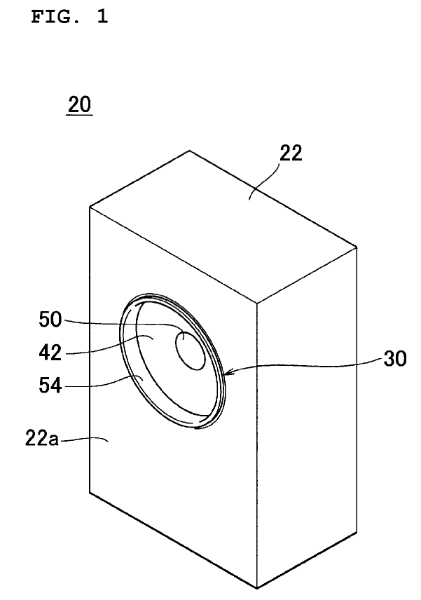

FIG. 1 is a perspective view showing an example of a speaker unit including a speaker according to a preferred embodiment of the present invention. A speaker unit 20 includes a cabinet 22 that is in the shape of, for example, a substantially rectangular box. A surface 22a of the cabinet 22 includes an opening that is, for example, substantially circular in shape.

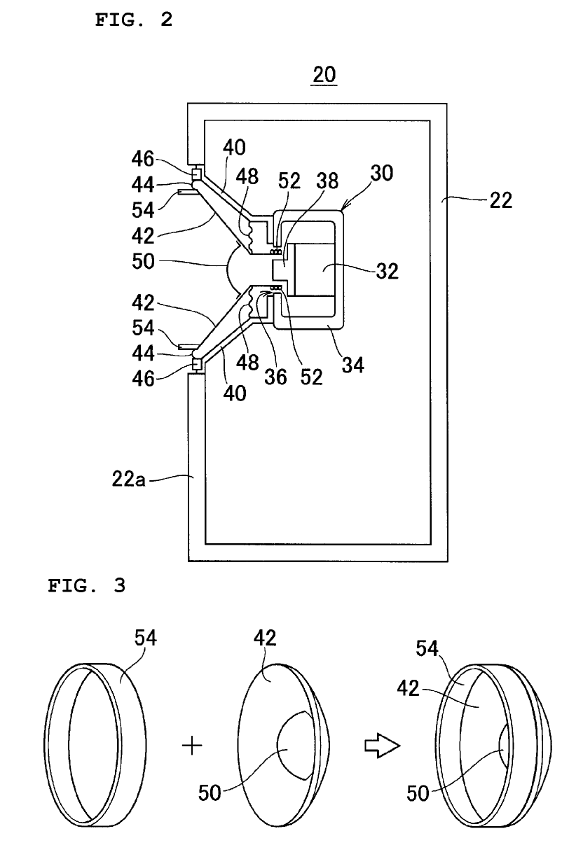

As shown in FIG. 2, a speaker 30 is attached to the inside of the cabinet 22 facing the opening. The speaker 30 includes a permanent magnet 32 attached at one end to the inside bottom of a yoke 34. The yoke 34 is made of magnetic material and surrounds the permanent magnet 32. The yoke 34 includes a circular hole 36 at the other end of the permanent magnet 32. A columnar center pole 38 attached to the other end of the permanent magnet 32 extends inside the hole 36 of the yoke 34, thereby creating an annular gap between the yoke 34 and the center pole 38. This structure enables a magnetic field to be applied to the annular gap between the yoke 34 and the center pole 38.

A tapered frame 40 is attached to the outside of the yoke 34 around the hole 36. A diaphragm 42 is disposed inside the frame 40. The diaphragm 42 is preferably made of paper or other suitable material and preferably has a conical shape. The small-diameter end of the diaphragm 42 is fitted in the gap between the yoke 34 and the center pole 38. The large-diameter end of the diaphragm 42 is connected to a curved cone edge 44. An end of the cone edge 44 is sandwiched and secured between an end of the frame 40 and a gasket 46. A midsection on the outside of the diaphragm 42 is connected via a damper 48 to the frame 40. A central “through” portion of the diaphragm 42 is covered with a cap 50 that has, for example, a semispherical shape.

In the gap between the yoke 34 and the center pole 38, a voice coil 52 is secured to the diaphragm 42. Audio signals input to the voice coil 52 cause the diaphragm 42 to vibrate in a direction that is substantially perpendicular to a plane extending across the large-diameter end connected to the cone edge 44. Moreover, as shown in FIG. 3, a frame-like wall member 54 having a cross-sectional shape that is substantially the same as the shape of the rim of the diaphragm 42 is attached to the large-diameter end of the diaphragm 42, that is, to the rim of the diaphragm 42. When the diaphragm 42 is conical in shape as shown in FIG. 3, the wall member 54 having a substantially circular cylindrical shape is attached to the diaphragm 42.

The wall member 54 is formed such that at least the inner surface thereof is substantially parallel to the direction in which the diaphragm 42 vibrates. In addition, the wall member 54 is formed such that the height thereof from the diaphragm 42 is substantially the same as the maximum amplitude of the diaphragm 42. It is preferable that the wall member 54 be made of light and durable material. The wall member 54 can be made of the same material as that of the diaphragm 42. Examples of the material for the wall member 54 include, but are not limited to, paper, resin, rubber, wood, and metal. One end of the substantially circular cylindrical wall member 54 is secured to the rim of the diaphragm 42. The rim of the frame 40 of the speaker 30 is attached to the opening in the surface 22a of the cabinet 22.

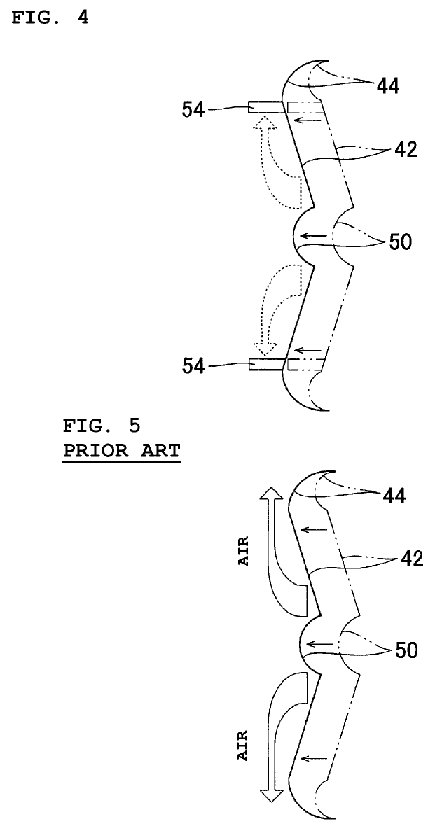

In the speaker unit 20, audio signals input to the voice coil 52 cause the diaphragm 42 to vibrate in a direction extending along the surface 22a of the cabinet 22, and sound waves are emitted in the vibration direction of the diaphragm 42. As shown in FIG. 4, when the diaphragm 42 moves with the wall member 54 to the sound-wave emission side, that is, in the forward direction, air in front of the diaphragm 42 is compressed and then released from the opening side of the wall member 54. The resulting shock propagates and is perceived as sound. When the vibration of the diaphragm 42 causes air to be compressed as described above, the wall member 54 on the rim of the diaphragm 42 prevents the compressed air from leaking from the front to the side of the diaphragm 42, as indicated by dotted arrows in FIG. 4. Therefore, air in front of the diaphragm 42 is reliably captured, compressed, and efficiently released forward. A speaker that is capable of reproducing sounds of all frequencies ranging from low to high frequencies that accurately corresponds to input signals, and in particular, capable of reproducing low frequency sounds even with a small diameter is thus provided.

On the other hand, if the diaphragm 42 does not include a wall member on the rim, air compressed by the vibration of the diaphragm 42 leaks from the front to the side of the diaphragm 42, as indicated by solid arrows in FIG. 5. In this case, since air in front of the diaphragm 42 cannot be efficiently compressed and the diaphragm 42 has to have a large diameter and provide a longer airflow distance to reproduce low frequency sounds, reproduction of sounds that accurately corresponds to input signals cannot be achieved.

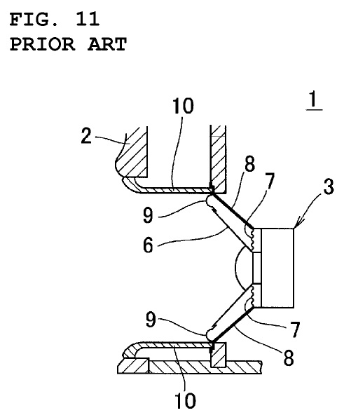

In the conventional speaker unit 1 shown in FIG. 11, the duct 10 is provided in front of the woofer 3. However, since the diaphragm 6 of the woofer 3 and the duct 10 are not secured to each other, a gap between the diaphragm 6 and the duct 10 allows air to leak therefrom. Therefore, it is not possible to achieve effects that are similar to those achieved by the speaker 30 having the diaphragm 42 provided with the wall member 54. Moreover, the duct 10 is provided for resonance purposes to produce low frequency sounds, and thus, has a problem in that the resonance causes sound distortion.

On the other hand, the speaker 30 according to preferred embodiments of the present invention reproduces sounds without distortion, since the wall member 54 having substantially the same height as the maximum amplitude of the diaphragm 42 produces no resonance. Even if the height of the wall member 54 is less than the maximum amplitude of the diaphragm 42, it is still possible to prevent leakage of compressed air from the front to the side of the diaphragm 42. However, to capture all the air in front of the diaphragm 42, the height of the wall member 54 is preferably substantially the same as the maximum amplitude of the diaphragm 42. To capture all the air in front of the diaphragm 42, the height of the wall member 54 may exceed the maximum amplitude of the diaphragm 42 to the extent that the wall member 54 does not restrict the vibrations of the diaphragm 42.

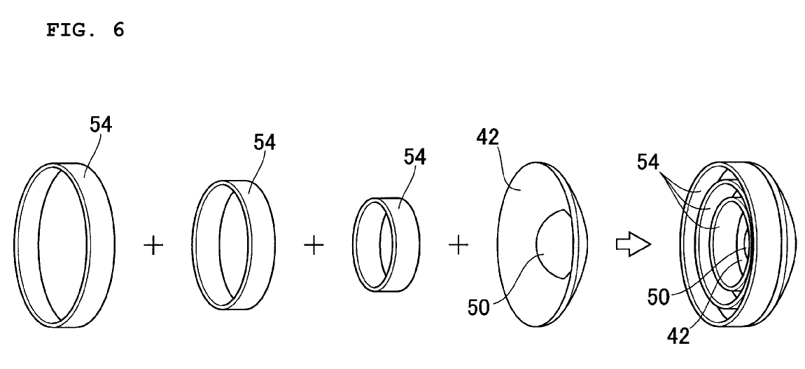

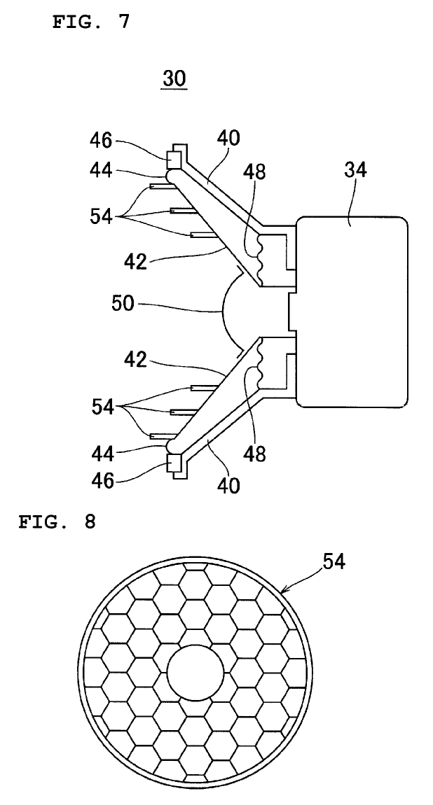

As shown in FIG. 6 and FIG. 7, a plurality of wall members 54, each having a cross-sectional shape that is similar to the shape of the rim of the diaphragm 42, may be arranged to provide a plurality of sections. These wall members 54 are arranged concentrically with respect to the center of the diaphragm 42, and configured such that every wall member 54 has substantially the same height as the maximum amplitude of the diaphragm 42. When the height of the wall members 54 is equal to the maximum moving distance of the diaphragm, air is reliably captured, compressed, and then released when the diaphragm 42 vibrates.

The diaphragm 42 provided with these wall members 54 interferes with the smooth flow of air captured when the diaphragm 42 vibrates, since the area of a section surrounded by each of the wall members 54 is smaller than when a single wall member 54 is provided only on the rim of the diaphragm 42. Therefore, it is possible to compress and release all of the air in front of the diaphragm 42, and reproduce sounds without distortion. Moreover, the wall members 54 on a surface of the diaphragm 42 act as ribs to improve the stiffness of the diaphragm 42. The diaphragm 42 thus is more resistant to deformation, such as surface waviness, and the reproduction of sounds that accurately corresponds to the original source is achieved.

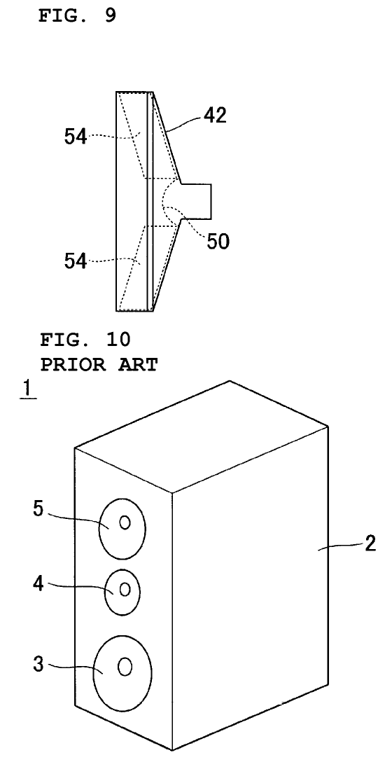

To similarly reduce the area of each surrounded section while acting as ribs, the wall member 54 may include tubular elements touching side by side. As shown in FIG. 8 and FIG. 9, the wall member 54 may have a honeycomb structure in which hexagonal tubes touch side by side. This wall member 54 is also configured such that the height thereof is substantially the same as the maximum amplitude of the diaphragm 42. The wall member 54 is disposed between the rim of the diaphragm 42 and the cap 50. The shape of each tubular element is not limited to a hexagonal shape, and may be a rectangular shape, a circular shape, or any other suitable shape.

As described above, the diaphragm 42 provided with the wall member 54 increases the efficiency of air compression when the diaphragm 42 vibrates, and enables the speaker 30 to reproduce low frequency sounds without distortion, even when the speaker 30 includes the diaphragm 42 having a small diameter.

Although it is preferable that the wall member and the rim of the diaphragm have substantially the same shape, the advantages of the present invention can be achieved even when a diaphragm having a circular rim is provided with a wall member having a substantially rectangular shape or other suitable shape.

The inside of the wall member preferably extends substantially parallel to the direction in which the diaphragm vibrates. However, the inside of the wall member may extend in a direction that is different from the vibration direction of the diaphragm. In other words, the inside of the wall member may be directed slightly inward.

The present invention is applicable not only to a speaker having a conical diaphragm, but also to a speaker having a diaphragm with a modified shape, such as a bell-shaped diaphragm that gradually extends in a sound-wave emission direction. In this case, the wall member is attached to the end portion of the diaphragm. The end portion of the diaphragm is a surface that is substantially perpendicular to the vibration direction of the diaphragm. When the wall member is substantially parallel to the vibration direction of the diaphragm, the surface at the end of the diaphragm is substantially perpendicular to the wall member. Again, the wall member may be directed slightly inward, in other words, toward the center of the speaker, such that the wall member crosses the vibration direction of the diaphragm.

The present invention is applicable not only to a speaker having a conical diaphragm, but also to a speaker having a flat diaphragm. Although the wall member shown in FIG. 8 and FIG. 9 is arranged on the diaphragm surface around the cap, the wall member may be arranged on the entire surface of the flat diaphragm.

The shape of the flat diaphragm is not limited to a substantially circular shape, but may be a substantially rectangular shape or other suitable shape. When the flat diaphragm has a substantially rectangular shape, the wall member on the rim of the diaphragm is configured in the shape of a substantially rectangular tube so as to correspond to the shape of the diaphragm. When the wall members are substantially rectangular tubes that are similar in shape, the wall members are arranged concentrically with respect to the center of the diaphragm. As described above, when a wall member is to be provided on the rim of the diaphragm or when a plurality of wall members is to be arranged concentrically, each wall member has a shape of a tube having a cross section that is substantially the same or similar in shape to the rim of the diaphragm. Such wall members are applicable to any speaker having a diaphragm that vibrates in a direction extending along a flat surface.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-8. (canceled)

9. A speaker comprising:
a diaphragm arranged to vibrate in a direction extending along a surface of the speaker so as to emit sound waves in a vibration direction of the diaphragm; and
at least one wall member arranged on a sound-wave emission side of the diaphragm; wherein
the at least one wall member and the diaphragm are secured to each other, and the wall member vibrates along with the vibration of the diaphragm.

10. The speaker according to claim 9, wherein the inner surface of the at least one wall member is arranged substantially parallel to the vibration direction of the diaphragm.

11. The speaker according to claim 9, wherein the at least one wall member includes a frame surrounding the sound-wave emission side of the diaphragm.

12. The speaker according to claim 9, wherein the at least one wall member has a cross-sectional shape that is substantially the same as a shape of a rim of the sound-wave emission surface of the diaphragm.

13. The speaker according to claim 9, wherein the at least one wall member includes a plurality of wall members that are arranged concentrically with respect to a center of the diaphragm.

14. The speaker according to claim 9, wherein a height of the at least one wall member is substantially the same as a maximum amplitude of the diaphragm.

15. A speaker comprising:
a diaphragm arranged to vibrate in a direction extending along a surface of the speaker so as to emit sound waves in a vibration direction of the diaphragm; and
a plurality of tubular elements touching and arranged side by side on a sound-wave emission side of the diaphragm, each of the plurality of tubular elements having an inner surface extending substantially parallel to a vibration direction of the diaphragm; wherein
the plurality of tubular elements and the diaphragm are secured to each other, and the plurality of tubular elements vibrate along with the vibration of the diaphragm.

16. The speaker according to claim 15, wherein a height of each of the plurality of tubular elements is substantially the same as a maximum amplitude of the diaphragm.

17. A speaker unit comprising:
a cabinet including a surface having an opening therein;
a speaker attached to an inner side of the surface and aligned with the opening; wherein
the speaker includes:
a diaphragm arranged to vibrate in a direction extending along a surface of the speaker so as to emit sound waves in a vibration direction of the diaphragm; and
at least one wall member arranged on a sound-wave emission side of the diaphragm; wherein
the at least one wall member and the diaphragm are secured to each other, and the wall member vibrates along with the vibration of the diaphragm.

18. The speaker unit according to claim 17, wherein the inner surface of the at least one wall member is arranged substantially parallel to the vibration direction of the diaphragm.

19. The speaker unit according to claim 17, wherein the at least one wall member includes a frame surrounding the sound-wave emission side of the diaphragm.

20. The speaker unit according to claim 17, wherein the at least one wall member has a cross-sectional shape that is substantially the same as a shape of a rim of the sound-wave emission surface of the diaphragm.

21. The speaker unit according to claim 17, wherein the at least one wall member includes a plurality of wall members that are arranged concentrically with respect to a center of the diaphragm.

22. The speaker unit according to claim 17, wherein a height of the at least one wall member is substantially the same as a maximum amplitude of the diaphragm.

23. The speaker unit according to claim 17, wherein the cabinet has a substantially rectangular box-shaped configuration.

24. A speaker unit comprising:
a cabinet including a surface having an opening therein;
a speaker attached to an inner side of the surface and aligned with the opening; wherein
the speaker includes:
a diaphragm arranged to vibrate in a direction extending along a surface of the speaker so as to emit sound waves in a vibration direction of the diaphragm; and
a plurality of tubular elements touching and arranged side by side on a sound-wave emission side of the diaphragm, each of the plurality of tubular elements having an inner surface extending substantially parallel to a vibration direction of the diaphragm; wherein
the plurality of tubular elements and the diaphragm are secured to each other, and the plurality of tubular elements vibrate along with the vibration of the diaphragm.

25. The speaker unit according to claim 24, wherein a height of each of the plurality of tubular elements is substantially the same as a maximum amplitude of the diaphragm.

26. The speaker unit according to claim 24, wherein the cabinet has a substantially rectangular box-shaped configuration.
